(19) United States
(12) Patent Application Publication
(10) Pub. No.: US 2024/0265130 A1
(43) Pub. Date: Aug. 8, 2024

(54) Intelligent Personally Identifiable Information Governance and Enforcement

(71) Applicant: Dell Products L.P., Round Rock, TX (US)

(72) Inventors: Shamik Kacker, Austin, TX (US); Bijan Kumar Mohanty, Austin, TX (US); Hung Dinh, Austin, TX (US)

(73) Assignee: Dell Products L.P., Round Rock, TX (US)

(21) Appl. No.: 18/165,957

(22) Filed: Feb. 8, 2023

(51) Int. Cl. G06F 21/62; G06F 21/60

(52) U.S. Cl. CPC G06F 21/6245; G06F 21/604

(57) ABSTRACT

In one aspect, an example methodology implementing the disclosed techniques includes, by a computing device, receiving a data access event, wherein the data access event relates to a data element and determining whether the data element is a personally identifiable information (PII) data element. The method also includes, responsive to a determination that the data element is a PII data element, by the computing device, predicting, using a machine learning (ML) model, a PII protection policy appropriate for the PII data element, and applying the PII protection policy to the PII data element. The method further includes, by the computing device, returning the data access event including the PII data element with the PII protection policy applied.

### BACKGROUND

Data governance refers to a person's ability to determine for themselves when, how, and to what extent personal information about them is shared with or communicated to others. Personally identifiable information (PII) can be, for example, one's name, location, contact information, government identification numbers, financial account numbers, online or real-world behavior, etc. Web sites, applications, and social media platforms often need to collect and store personal data about users to provide services.

With the advent of 5^{th} generation (5G) mobile networks and Internet of Things (IoT) devices, organizations are generating and consuming significant amounts of personal information. Organizations that generate and/or consume PII are continually faced with the challenges related to data privacy and data protection.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In accordance with one illustrative embodiment provided to illustrate the broader concepts, systems, and techniques described herein, a method includes, by a computing device, receiving a data access event, wherein the data access event relates to a data element and determining whether the data element is a personally identifiable information (PII) data element. The method also includes, responsive to a determination that the data element is a PII data element, by the computing device, predicting, using a machine learning (ML) model, a PII protection policy appropriate for the PII data element, and applying the PII protection policy to the PII data element. The method further includes, by the computing device, returning the data access event including the PII data element with the PII protection policy applied.

In some embodiments, the data access event includes an access of a database.

In some embodiments, the ML model includes a CatBoost classifier.

In some embodiments, the ML model is trained with training data comprising historical PII protection data.

In some embodiments, the method also includes, responsive to a determination that the data element is not a PII data element, returning, by the computing device, the data access event.

In some embodiments, determining whether the data element is a PII data element includes querying a PII metadata repository, wherein the PII metadata repository maintains PII data of an organization.

In some embodiments, the data access event is from another computing device.

According to another illustrative embodiment provided to illustrate the broader concepts described herein, a system includes one or more non-transitory machine-readable mediums configured to store instructions and one or more processors configured to execute the instructions stored on the one or more non-transitory machine-readable mediums. Execution of the instructions causes the one or more processors to carry out a process corresponding to the aforementioned method or any described embodiment thereof

According to another illustrative embodiment provided to illustrate the broader concepts described herein, a non-transitory machine-readable medium encodes instructions that when executed by one or more processors cause a process to be carried out, the process corresponding to the aforementioned method or any described embodiment thereof

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the claims appended hereto.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram illustrating an example network environment of computing devices in which various aspects of the disclosure may be implemented, in accordance with an embodiment of the present disclosure.

FIG. 2 is a block diagram illustrating selective components of an example computing device in which various aspects of the disclosure may be implemented, in accordance with an embodiment of the present disclosure.

FIG. 3 is a diagram of a cloud computing environment in which various aspects of the concepts described herein may be implemented.

FIG. 4 is a block diagram of an illustrative system for intelligent personally identifiable information (PII) governance and enforcement, in accordance with an embodiment of the present disclosure.

FIG. 5A is a diagram illustrating an example of a resource description framework (RDF) based relationship graph, in accordance with an embodiment of the present disclosure.

FIG. 5B is a diagram illustrating an example of a labeled property graph (LPG) based relationship graph, in accordance with an embodiment of the present disclosure.

FIG. 6 shows a diagram of an example topology that can be used to predict a personally identifiable information (PII) protection policy, in accordance with an embodiment of the present disclosure.

FIG. 7 is a flow diagram of an example process for determining an appropriate personally identifiable information (PII) protection policy for a data access event and applying the PII protection policy to a PII data element in the data access event, in accordance with an embodiment of the present disclosure.

### DETAILED DESCRIPTION

Many jurisdictions have enacted data protection and privacy legislation and/or regulations, such as the General Data Protection Regulation (GDPR), governing how to obtain, use, and store data corresponding to PII. In general, the regulations state that data corresponding to PII should be processed in a lawful, fair, and transparent manner, be collected for specified, explicit, and legitimate purposes, be adequate, relevant and limited to what is necessary in relation to the purpose for which the data is being processed (data minimization), be accurate, be maintained no longer than necessary, and be processed in a manner that ensures appropriate security. Organizations may face significant penalties if they are not compliant with the enacted data protection and privacy regulations. Organizations need to determine whether specific regulations are applicable to their organizational practices and comply with such regulations to avoid incurring the fines and penalties for non-compliance.

Certain embodiments of the concepts, techniques, and structures disclosed herein are directed to an intelligent personally identifiable information (PII) governance and enforcement framework. The framework provides for identifying/detecting PII data at the time of data access, predicting an appropriate PII protection policy for that data access, and applying the PII protection policy to the PII data before providing the data. For example, data and messaging access may be generated from various applications to databases, caching systems, application program interfaces (APIs), messaging systems, and streaming systems, among others, for all types of data elements that can potentially have PII data. Before the data element is accessed and returned, a check is performed to determine whether the data element being accessed is of PII data. If the determination is that the data element is not a PII data element, the data access is allowed to continue. Conversely, if the determination is that the data element is a PII data element, a prediction of a PII protection policy that is appropriate for the PII data element (i.e., appropriate for the PII data) is performed. The predicted PII protection policy is then applied to the data element before returning to a requester of the data element.

In some embodiments, a trained machine learning (ML) model can be leveraged to predict a PII protection policy to apply to a PII data element for PII data governance. For example, training data for training the ML model can include historical PII protection data. The training data can be used to train an ML model, where the training data can configure the ML model to learn trends in the data. As such, the trained ML model can be effective at predicting an appropriate PII protection policy for a PII data element. In other words, when a requested data element is determined to be a PII data element, details of the data element can be input to the trained ML model to predict an appropriate PII protection policy for the PII data element.

As used herein, the term “personally identifiable information (PII)” refers to any information that can be used to distinguish or trace an individual's identity, such as, but not necessarily limited to, name, social security number, date and place of birth, mother's maiden name and/or biometric records, or any other information that is linked or linkable to an individual, such as, but not necessarily limited to, medical, educational, financial, and/or employment information. See National Institute of Standards and Technology (NIST) Special Publication 800-122 (2010). Some other non-limiting examples of PII include, but are not necessarily limited to, financial transactions, medical history, criminal history, employment history, aliases, residential and mailing addresses, Internet Protocol (IP) addresses, email addresses, online identifiers, passport number, driver's license number, government issued identification numbers, telephone numbers, credit card numbers, vehicle registrations, x-rays, patient identification (ID) numbers, and biometric data (e.g., retina scan, voice signature, facial geometry, etc.).

As used herein, the term “data access event” refers to any type of data access, such as a request to access data. A data access event can be initiated by a user or initiated in response to an action taken by a user. A data access event relates to one or more data elements and is how users can get access to the data elements. For example, data access events may include, but are not limited to, database queries, API access, cache access, messaging events, and events/actions on data, such as retrieving, modifying, copying, or moving data elements. For example, data access events can be generated from various applications to database systems, caching systems, APIs, messaging, and streaming systems for all kinds of data elements.

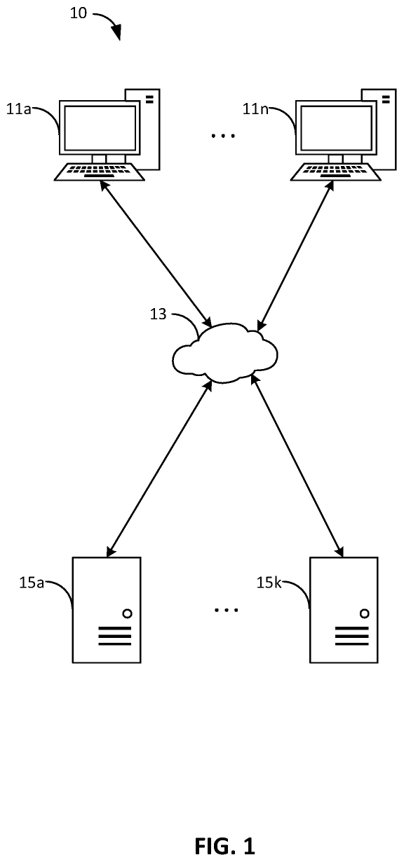

Referring now to FIG. 1, shown is a diagram illustrating an example network environment 10 of computing devices in which various aspects of the disclosure may be implemented, in accordance with an embodiment of the present disclosure. As shown, environment 10 includes one or more client machines 11a-11n (11 generally), one or more server machines 15a-15k (15 generally), and one or more networks 13. Client machines 11 can communicate with server machines 15 via networks 13. Generally, in accordance with client-server principles, a client machine 11 requests, via network 13, that a server machine 15 perform a computation or other function, and server machine 15 responsively fulfills the request, optionally returning a result or status indicator in a response to client machine 11 via network 13.

In some embodiments, client machines 11 can communicate with remote machines 15 via one or more intermediary appliances (not shown). The intermediary appliances may be positioned within network 13 or between networks 13. An intermediary appliance may be referred to as a network interface or gateway. In some implementations, the intermediary appliance may operate as an application delivery controller (ADC) in a datacenter to provide client machines (e.g., client machines 11) with access to business applications and other data deployed in the datacenter. The intermediary appliance may provide client machines with access to applications and other data deployed in a cloud computing environment, or delivered as Software as a Service (SaaS) across a range of client devices, and/or provide other functionality such as load balancing, etc.

Client machines 11 may be generally referred to as computing devices 11, client devices 11, client computers 11, clients 11, client nodes 11, endpoints 11, or endpoint nodes 11. Client machines 11 can include, for example, desktop computing devices, laptop computing devices, tablet computing devices, mobile computing devices, workstations, and/or hand-held computing devices. Server machines 15 may also be generally referred to a server farm 15. In some embodiments, a client machine 11 may have the capacity to function as both a client seeking access to resources provided by server machine 15 and as a server machine 15 providing access to hosted resources for other client machines 11.

Server machine 15 may be any server type such as, for example, a file server, an application server, a web server, a proxy server, a virtualization server, a deployment server, a Secure Sockets Layer Virtual Private Network (SSL VPN) server; an active directory server; a cloud server; or a server executing an application acceleration program that provides firewall functionality, application functionality, or load balancing functionality. Server machine 15 may execute, operate, or otherwise provide one or more applications. Non-limiting examples of applications that can be provided include software, a program, executable instructions, a virtual machine, a hypervisor, a web browser, a web-based client, a client-server application, a thin-client, a streaming application, a communication application, or any other set of executable instructions.

In some embodiments, server machine 15 may execute a virtual machine providing, to a user of client machine 11, access to a computing environment. In such embodiments, client machine 11 may be a virtual machine. The virtual machine may be managed by, for example, a hypervisor, a virtual machine manager (VMM), or any other hardware virtualization technique implemented within server machine 15.

Networks 13 may be configured in any combination of wired and wireless networks. Network 13 can be one or more of a local-area network (LAN), a wide area network (WAN), a metropolitan area network (MAN), a virtual private network (VPN), a primary public network, a primary private network, the Internet, or any other type of data network. In some embodiments, at least a portion of the functionality associated with network 13 can be provided by a cellular data network and/or mobile communication network to facilitate communication among mobile devices. For short range communications within a wireless local-area network (WLAN), the protocols may include 802.11, Bluetooth, and Near Field Communication (NFC).

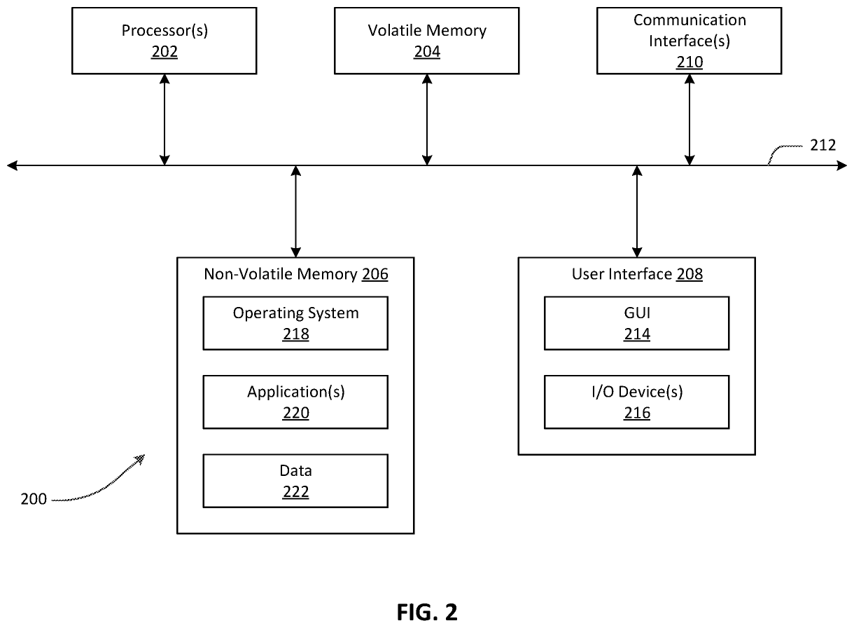

FIG. 2 is a block diagram illustrating selective components of an example computing device 200 in which various aspects of the disclosure may be implemented, in accordance with an embodiment of the present disclosure. For instance, client machines 11 and/or server machines 15 of FIG. 1 can be substantially similar to computing device 200. As shown, computing device 200 includes one or more processors 202, a volatile memory 204 (e.g., random access memory (RAM)), a non-volatile memory 206, a user interface (UI) 208, one or more communications interfaces 210, and a communications bus 212.

Non-volatile memory 206 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof

User interface 208 may include a graphical user interface (GUI) 214 (e.g., a touchscreen, a display, etc.) and one or more input/output (I/O) devices 216 (e.g., a mouse, a keyboard, a microphone, one or more speakers, one or more cameras, one or more biometric scanners, one or more environmental sensors, and one or more accelerometers, etc.).

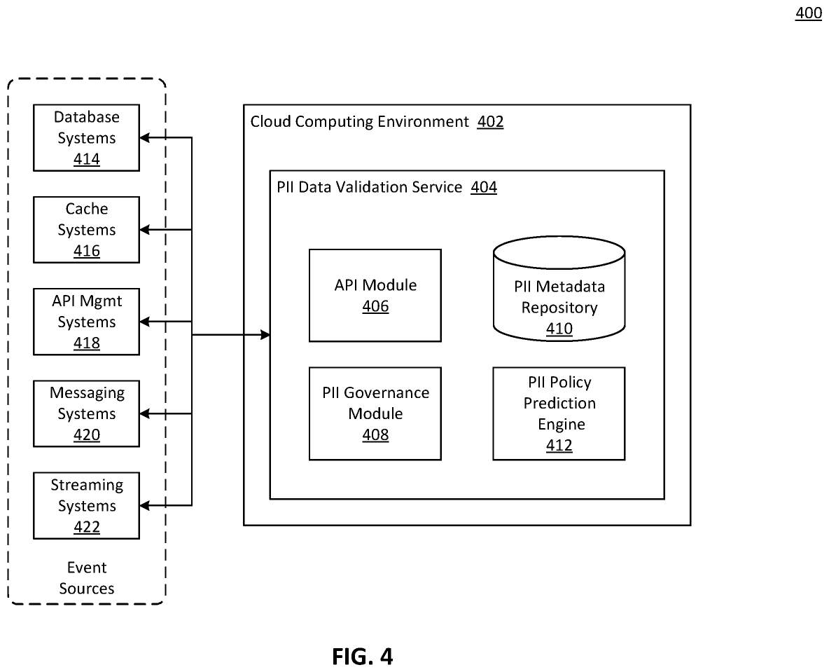

Non-volatile memory 206 stores an operating system 218, one or more applications 220, and data 222 such that, for example, computer instructions of operating system 218 and/or applications 220 are executed by processor(s) 202 out of volatile memory 204. In one example, computer instructions of operating system 218 and/or applications 220 are executed by processor(s) 202 out of volatile memory 204 to perform all or part of the processes described herein (e.g., processes illustrated and described with reference to FIGS. 4 through 6). In some embodiments, volatile memory 204 may include one or more types of RAM and/or a cache memory that may offer a faster response time than a main memory. Data may be entered using an input device of GUI 214 or received from I/O device(s) 216. Various elements of computing device 200 may communicate via communications bus 212.

The illustrated computing device 200 is shown merely as an illustrative client device or server and may be implemented by any computing or processing environment with any type of machine or set of machines that may have suitable hardware and/or software capable of operating as described herein.

Processor(s) 202 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 202 may be analog, digital or mixed signal. In some embodiments, processor 202 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 210 may include one or more interfaces to enable computing device 200 to access a computer network such as a Local Area Network (LAN), a Wide Area Network (WAN), a Personal Area Network (PAN), or the Internet through a variety of wired and/or wireless connections, including cellular connections.

In described embodiments, computing device 200 may execute an application on behalf of a user of a client device. For example, computing device 200 may execute one or more virtual machines managed by a hypervisor. Each virtual machine may provide an execution session within which applications execute on behalf of a user or a client device, such as a hosted desktop session. Computing device 200 may also execute a terminal services session to provide a hosted desktop environment. Computing device 200 may provide access to a remote computing environment including one or more applications, one or more desktop applications, and one or more desktop sessions in which one or more applications may execute.

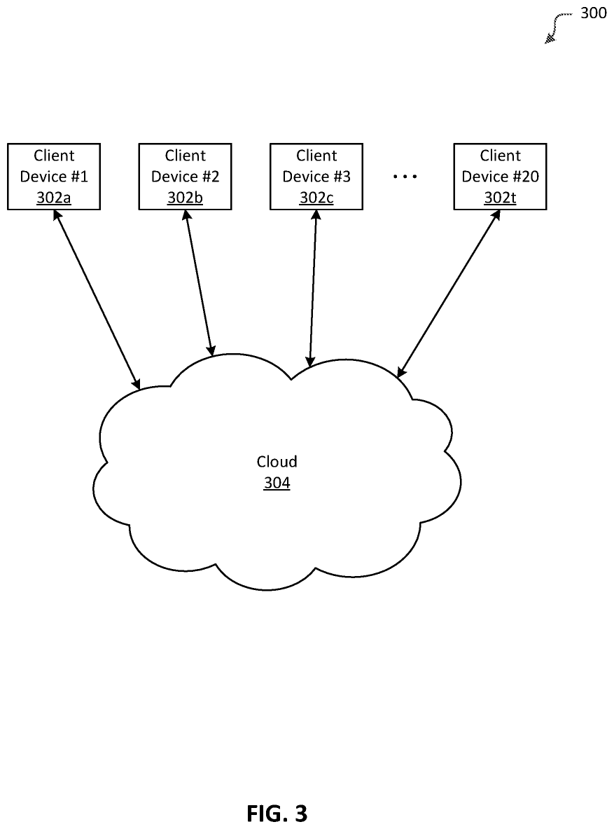

Referring to FIG. 3, shown is a diagram of a cloud computing environment 300 in which various aspects of the concepts described herein may be implemented. Cloud computing environment 300, which may also be referred to as a cloud environment, cloud computing, or cloud network, can provide the delivery of shared computing resources and/or services to one or more users or tenants. For example, the shared resources and services can include, but are not limited to, networks, network bandwidth, servers, processing, memory, storage, applications, virtual machines, databases, software, hardware, analytics, and intelligence.

In cloud computing environment 300, one or more client devices 302a-302t (such as client machines 11 and/or computing device 200 described above) may be in communication with a cloud network 304 (sometimes referred to herein more simply as a cloud 304). Cloud 304 may include back-end platforms such as, for example, servers, storage, server farms, or data centers. The users of clients 302a-302t can correspond to a single organization/tenant or multiple organizations/tenants. More particularly, in one implementation, cloud computing environment 300 may provide a private cloud serving a single organization (e.g., enterprise cloud). In other implementations, cloud computing environment 300 may provide a community or public cloud serving one or more organizations/tenants.

In some embodiments, one or more gateway appliances and/or services may be utilized to provide access to cloud computing resources and virtual sessions. For example, a gateway, implemented in hardware and/or software, may be deployed (e.g., reside) on-premises or on public clouds to provide users with secure access and single sign-on to virtual, SaaS, and web applications. As another example, a secure gateway may be deployed to protect users from web threats.

In some embodiments, cloud computing environment 300 may provide a hybrid cloud that is a combination of a public cloud and a private cloud. Public clouds may include public servers that are maintained by third parties to client devices 302a-302t or the enterprise/tenant. The servers may be located off-site in remote geographical locations or otherwise.

Cloud computing environment 300 can provide resource pooling to serve clients devices 302a-302t (e.g., users of client devices 302a-302n) through a multi-tenant environment or multi-tenant model with different physical and virtual resources dynamically assigned and reassigned responsive to different demands within the respective environment. The multi-tenant environment can include a system or architecture that can provide a single instance of software, an application, or a software application to serve multiple users. In some embodiments, cloud computing environment 300 can include or provide monitoring services to monitor, control, and/or generate reports corresponding to the provided shared resources and/or services.

In some embodiments, cloud computing environment 300 may provide cloud-based delivery of various types of cloud computing services, such as Software as a service (SaaS), Platform as a Service (PaaS), Infrastructure as a Service (IaaS), and/or Desktop as a Service (DaaS), for example. IaaS may refer to a user renting the use of infrastructure resources that are needed during a specified time period. IaaS providers may offer storage, networking, servers, or virtualization resources from large pools, allowing the users to quickly scale up by accessing more resources as needed. PaaS providers may offer functionality provided by IaaS, including, e.g., storage, networking, servers, or virtualization, as well as additional resources such as, for example, operating systems, middleware, and/or runtime resources. SaaS providers may offer the resources that PaaS provides, including storage, networking, servers, virtualization, operating systems, middleware, or runtime resources. SaaS providers may also offer additional resources such as, for example, data and application resources. DaaS (also known as hosted desktop services) is a form of virtual desktop service in which virtual desktop sessions are typically delivered as a cloud service along with the applications used on the virtual desktop.

FIG. 4 is a block diagram of an illustrative system 400 for intelligent personally identifiable information (PII) governance and enforcement, in accordance with an embodiment of the present disclosure. Illustrative system 400 includes a PII data validation service 404 provided within a cloud computing environment 402. Cloud computing environment 402 can be the same as or similar to cloud computing environment 300 of FIG. 3. In the example of FIG. 4, PII data validation service 404 can be provided as a service (e.g., a microservice) within cloud computing environment 402. An organization, such as a company, an enterprise, or other entity that collects and/or stores data may implement and/or utilize PII data validation service 404 to provide a framework for governance of PII data at the time of data access and enforcement of appropriate PII protection policies to comply with enacted data protection and privacy regulations. PII data validation service 404 can be implemented as computer instructions executable to perform the corresponding functions disclosed herein. PII data validation service 404 can be logically and/or physically organized into one or more components.

In the example of FIG. 4, PII data validation service 404 includes an API module 406, a PII governance module 408, a PII metadata repository 410, and a PII policy prediction engine 412. The various components of PII data validation service 404 can communicate or otherwise interact utilizing application program interfaces (APIs), such as, for example, a Representational State Transfer (RESTful) API, a Hypertext Transfer Protocol Secure (HTTPS) API, or another suitable API, including combinations thereof

PII data validation service 404 can include various other components (e.g., software and/or hardware components) which, for the sake of clarity, are not shown in FIG. 4. It is also appreciated that PII data validation service 404 may not include certain of the components depicted in FIG. 4. For example, in certain embodiments, PII data validation service 404 may not include one or more of the components illustrated in FIG. 4 (e.g., PII metadata repository 410), but PII data validation service 404 may connect or otherwise couple to the one or more components via a communication interface. Thus, it should be appreciated that numerous configurations of PII data validation service 404 can be implemented and the present disclosure is not intended to be limited to any particular one. That is, the degree of integration and distribution of the functional component(s) provided herein can vary greatly from one embodiment to the next, as will be appreciated in light of this disclosure.

In accordance with certain of the embodiments disclosed herein, PII data validation service 404 provides a communication mechanism whereby event sources (e.g., applications, systems, etc.) can send messages to PII data validation service 404 notifying of occurrences of events. For example, event sources can send messages (or “requests”) to PII data validation service 404 upon occurrences of data access events wherein the requests are received and processed by API module 406 or one or more other components of PII data validation service 404. Likewise, PII data validation service 404 can utilize API module 406 to send responses/messages to the event sources upon processing of the messages from the event sources notifying of the data access events, for example.

PII governance module 408 is operable to process data access events sent or otherwise provided by various event sources to govern (control) access to PII data elements in the data access events. The event sources can include, for example, systems and/or applications which provide access to data (e.g., data access). In some embodiments, at the time of a data access event (e.g., a database query), an event source can send the data access event to PII data validation service 404 for processing before returning a data element(s) being accessed or requested by the data access event. That is, at the time of a data access event for a data element, an event source can send the data access event to PII data validation service 404 for processing before returning the data element to a requester (e.g., an application) making the data access event. In some cases, depending on the data access event, the event source may also send information about the data access event (e.g., information about the requester of the data access event) along with the data access event. For the sake of clarity, a data access event and any information about the data access event is referred to herein more simply as “data access event.” As shown in FIG. 4, the data sources can include, for example, one or more database systems 414, cache systems 416, API management systems 418, messaging systems 420, and streaming systems 422. For example, at the time of a database query, database system 414 can send the database query to PII data validation service 404 for processing before retuning the database query. As another example, at the time of an API quest (or “API call”) by an application, API management system 418 can send the API request to PII data validation service 404 for processing before retuning the API request to the application. As another example, at the time of a message from an application, messaging system 420 can send the message to PII data validation service 404 for processing before sending the message to a consumer of the message. The event sources shown in FIG. 4 are merely illustrative and may vary from one organization to the next.

In some embodiments, responsive to a data access event being received, PII governance module 408 can check to determine whether a data element in the data access event is a PII data element. In other words, PII governance module 408 can check to determine whether the data access event relates to a PII data element. For example, in one implementation, PII governance module 408 can query PII metadata repository 410 to determine whether the data element is a PII data element. PII metadata repository 410 and other processing that can be implemented within PII metadata repository 410 is further described below. If the determination is that the data element in the data access event is not a PII data element (e.g., the data element is non-PII data), PII governance module 408 can return the data element in its normal state without modification/alternation to the event source that sent the data access event. In this case, since the data element is not PII data, the data element is returned without application of a PII protection policy.

Otherwise, if the determination is that the data element in the data access event is a PII data element (e.g., the data element is PII data), PII governance module 408 can determine whether there is a PII protection policy that needs to be applied to the PII data element. In other words, PII governance module 408 can check to determine whether the PII data element in the data access event needs to be processed in a manner as prescribed by the organization's PII protection policies to be compliant with enacted data protection and privacy regulations. For example, in one implementation, PII governance module 408 can use PII policy prediction engine 412 to determine a PII protection policy that needs to be applied to the PII data element. As will be further described below, PII policy prediction engine 412 can predict a PII protection policy that is optimal for the PII data element and recommend the PII protection policy for applying to the PII data element. PII governance module 408 can then apply the recommended PII protection policy to the PII data element. Upon application of the PII protection policy, PII governance module 408 can return the PII data element with the PII protection policy applied to the event source that sent the data access event. For example, if the PII protection policy specified to obfuscate the PII data element, PII governance module 408 can return the PII data element in an obfuscated state (e.g., obscured, blurred, or blacked out) to the event source.

PII metadata repository 410 is operable to store and manage the PII data associated with an organization. For example, in one embodiment, PII metadata repository 410 can store and manage PII data elements and their relationships in a central manner for scalability, high performance, and fast access to the data. The other elements may include, for example, other attributes of the PII data elements, wherein the other attributes include PII or do not include PII. For example, PII metadata repository 410 can store related PII, such as different types of PII for the same person, or PII related by category (e.g., medical PII, financial PII, etc.). In addition, PII data may be related to other data that is not PII. For example, a customer and their PII may be associated with a particular order, marketing information, or supply chain information that is not PII.

In some embodiments, PII metadata repository 410 can leverage a graph database to store and manage the PII data elements and their relationships. The graph database can be provided as any type of database and/or datastore capable of storing unstructured data objects (e.g., objects having arbitrary formats and attributes) and relationships between such objects, and of efficiently querying stored objects and relationships. Within the graph database, data objects may be treated as nodes of a graph and relationships between data objects may be treated as edges of the graph. In this way, the relationship graphs in the graph database can provide a knowledge base of PII for the organization. In some embodiments, the graph database may be provided as a triplestore, meaning a database that stores arbitrary data objects and relationships as 3-tuples or “triples” (in contrast to relational databases where data is stored within defined structured tables having a predefined set of attributes).

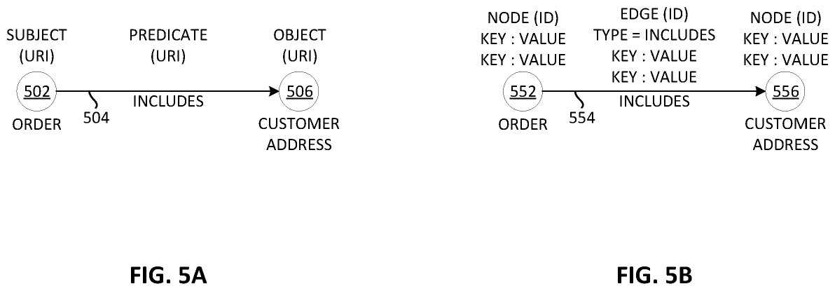

In one implementation, as illustrated in FIG. 5A, the graph database may be based on a graph model referred to as Resource Description Framework (RDF). An RDF based graph database stores data in the form of triple statements comprising a subject, a predicate, and an object. The predicates (relationships) that join nodes together confer semantic meaning upon the data. In the example of FIG. 5A, a node 502 labeled “order” represents a subject (e.g., a product order), an edge 504 labeled “includes” represents a predicate (e.g., relationship between nodes), and a node 506 labeled “customer address” represents an object (e.g., an address of a customer placing the product order). In the example, node 502 is connected to node 506 by edge 504 labeled “includes,” indicating that the order includes the customer address, which can be considered PII data. In RDF graphs, the nodes and edges can be identified by unique identifiers (URIs), which can be used to label the nodes and edges.

In another implementation, as illustrated in FIG. 5B, the graph database may be based on a graph model referred to as labeled property graph (LPG). With a labeled property graph, each entity can be represented as a node with a uniquely identifiable ID and can have metadata (properties) assigned to them in the form of a set of key-value pairs that characterize the entity. The relationship between two entities comprises an edge, which is a connection between the nodes. Each relationship can be uniquely identified by a uniquely identifiable ID and can have metadata (properties) assigned to them in the form of a set of key-value pairs that characterize the relationship. In the example of FIG. 5B, a node 552 labeled “order” represents a first entity, (e.g., a product order), an edge 554 labeled “includes” represents a relationship (e.g., relationship between entities), and a node 556 labeled “customer address” represents a second entity (e.g., an address of a customer placing the product order). In the example, a first entity (node 552) is connected to a second entity (node 556) by edge 554 labeled “includes,” indicating that the order includes the customer address, which can be considered PII data. While two key-value pairs are shown as corresponding to each entity and relationship, the embodiments are not necessarily limited thereto, and more or less than two key-value pairs may be used to identify and characterize the nodes and edges.

Referring again to FIG. 4, according to one or more embodiments, PII metadata repository 410 can store relationship graphs in the graph database and provide relationship data from the relationship graphs in response to queries or other inputs. The graphical format permits data analysis and traversal at multiple levels in real-time and enables the real-time addition of new context and connections. Advantageously, PII metadata repository 410 can be understood as providing a foundation for maintaining PII data of an organization, which accelerates the growth and sustenance of long-term knowledge. PII metadata repository 410 can be enriched with raw and derived data over time, resulting in graphs that include increasing levels of detail, context, truth, intelligence, and semantics. The graphical format is more indicative of a user's real-world ecosystem and domain than other representations of data and provides a more efficient mechanism for search and retrieval of information than other approaches. Data can be retrieved from PII metadata repository 410 using a variety of query languages capable of traversing graphs such as, but not necessarily limited to, formats including structured query language (SQL) and SPARQL. Some non-limiting examples of graph traversal languages that may be used with PII metadata repository 410 include Gremlin, Cypher, GraphQL, and/or Graphene. GraphQL and Graphene are languages for APIs (e.g., API(s) 145) to access the data in the graph database.

PII policy prediction engine 412 is operable to predict a PII protection policy for a particular PII data element. In other words, PII policy prediction engine 412 is operable to predict, for specified details about a data access event comprising a PII data element, a PII protection policy that is optimal for the specified details. The predicted PII protection policy can be recommended for applying to the PII data element in the data access event to comply with enacted data protection and privacy regulations. For example, a PII protection policy may specify how a PII data element is to be redacted before the PII data element is provided in response to a data access event comprising the PII data element. As another example, a PII protection policy may specify different levels of protection for a PII data element depending on the type of data access event. As another example, a PII protection policy may specify that the data access of the PII data element be denied. As a further example, a PII protection policy may specify that the PII data element be restricted or masked (e.g., anonymized) based on the identity of the requester. In general, the PII protection policy defines the action or actions that are to be taken to comply with the enacted data protection and privacy regulations (e.g., rules to comply with the enacted data protection and privacy regulations).

In some embodiments, PII policy prediction engine 412 can implement or include a categorical boosting (e.g., CatBoost) algorithm for prediction of a PII protection policy. The CatBoost algorithm is a decision tree based, ensemble algorithm that utilizes a shallow learning approach. Shallow learning, as opposed to deep learning, can be more appropriate in cases whether there are a smaller number of data dimensions. The CatBoost algorithm is a customized version of a gradient boosting algorithm that can work on categorical data in a training dataset without utilizing expensive encoding mechanisms. The CatBoost algorithm can handle a target variable (e.g., PII protection policy) having many unique values (e.g., hundreds of different PII protection polices for global organizations). The CatBoost algorithm uses multiple classifiers (e.g., decision trees) to generate the prediction. Each classifier may be trained on different data samples and different features. This reduces the variance and the bias stemming from using a single classifier. The final classification (e.g., PII protection policy) can be achieved by aggregating the predictions made by the different classifiers.

The CatBoost algorithm is an ensemble algorithm that combines several weak learners into a strong learner to generate the prediction. By combining multiple weak learners and learning from the errors of the weak learners (e.g., each succeeding model fixes the error of its preceding model), the algorithm can improve the predictions in a sequential manner. In addition to the previously mentioned ability to handle categorical data without encoding, additional advantages to the CatBoost algorithm are its high performance and simple hyperparameter tuning.

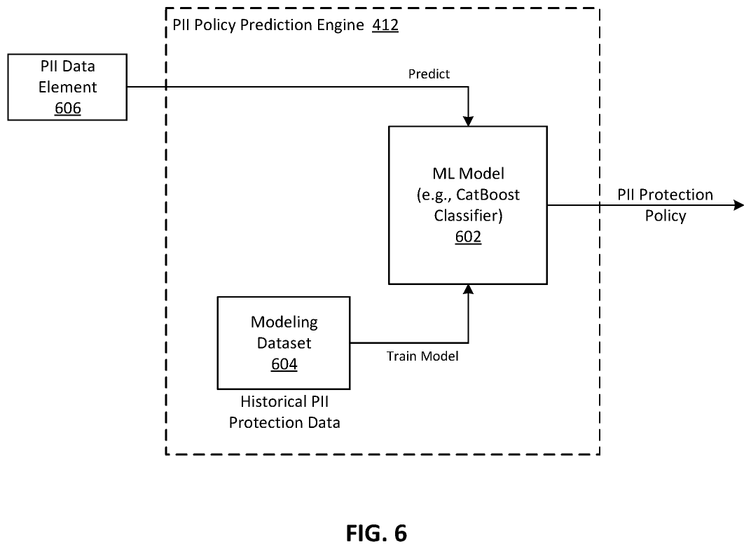

Referring now to FIG. 6, in which like elements of FIG. 4 are shown using like reference designators, shown a diagram of an example topology that can be used to predict a PII protection policy, in accordance with an embodiment of the present disclosure. As shown in FIG. 6, PII policy prediction engine 412 implements or includes an ML model 602. According to one embodiment, ML model 602 can be a CatBoost classifier generated using a CatBoost algorithm, as described previously. ML model 602 can be trained and tested/validated using machine learning techniques with a modeling dataset 604 composed of historical PII protection data. Each observation or instance in modeling dataset 604 may be composed of multi-dimensional features (i.e., independent variables) extracted from a historical PII data element and a PII protection policy (i.e., a dependent or target variable) applied to the historical PII data element to comply with enacted data protection and privacy regulations. Non-limiting examples of such features include element name (e.g., name of the PII data elements such as order, customer, etc.), a data type (e.g., type of PII data element such as “Regulated,” “Confidential,” “Sensitive,” and “High Risk”), and an access channel (e.g., database, API, messaging, etc.). The target variable is the PII protection policy predicted by ML model 602 (i.e., predicted by the CatBoost classifier).

In one implementation, modeling dataset 604 can be separated into two (2) groups: one for training ML model 602 (e.g., the CatBoost classifier) and the other for testing and validating (or “evaluating”) ML model 602. For example, based on the size of modeling dataset 604, approximately 70% of modeling dataset 604 can be designated for training ML model 602 and the remaining portion (approximately 30%) of modeling dataset 604 can be designated for testing and validating ML model 602.

In one embodiment, ML model 602 can be composed of multiple decision trees. Each decision tree may be constructed using different features and different data samples, which reduces the bias and variance. In a training process, the decision trees can be constructed using the portion of modeling dataset 604 designated for training (e.g., approximately 70% of modeling dataset 604). In a testing process, each new prediction that needs to be made (e.g., the portion of modeling dataset 604 not used in the training process) runs through the different decision trees whereby each decision tree yields a score, and a final prediction can be determined by voting (e.g., which class received the most votes). For instance, the CatBoost classifier uses multi-class classification, meaning the results of the classification would be one of many different PII protection policies.

For example, as shown in FIG. 6, PII policy prediction engine 412 can generate a feature vector 606 that represents details of a PII data element, such as, for example, element name, data type, and access channel. Feature vector 606 can be input, passed, or otherwise provided to the trained ML model 602. In some embodiments, the input feature vector 606 (e.g., the feature vector representing the PII data element) may include some or all the relevant features which were used in training ML model 602 (e.g., features that are relevant to (or influential in) predicting a PII protection policy). In response to the input, the trained ML model 602 can output a prediction of a PII protection policy for the input PII data element. The predicted PII protection policy can be recommended for applying to the input PII data element.

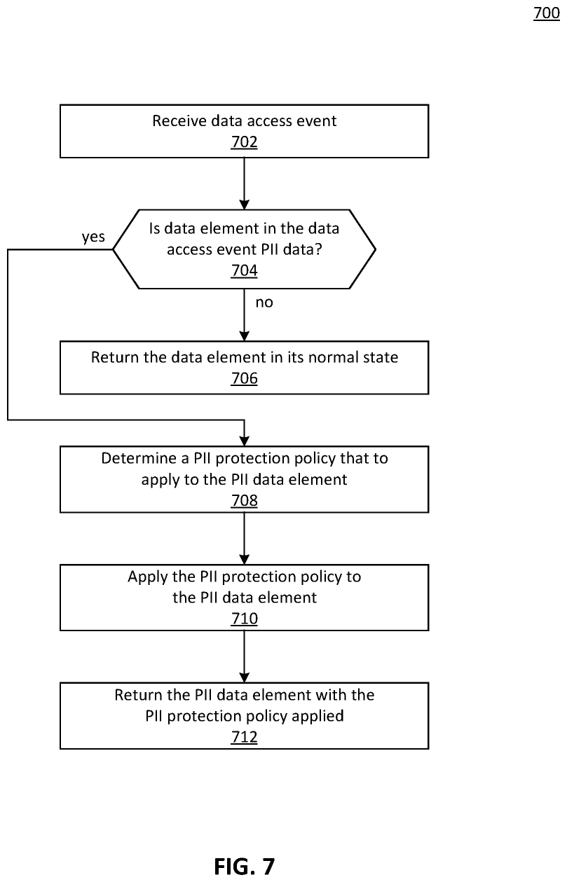

FIG. 7 is a flow diagram of an example process 700 for determining an appropriate personally identifiable information (PII) protection policy for a data access event and applying the PII protection policy to a PII data element in the data access event, in accordance with an embodiment of the present disclosure. Illustrative process 700 may be implemented, for example, within system 400 of FIG. 4. In more detail, process 700 may be performed, for example, in whole or in part by PII governance module 408, PII metadata repository 410, and PII policy prediction engine 412, or any combination of these including other components of system 400 described with respect to FIG. 4.

With reference to process 700 of FIG. 7, at 702, a data access event may be received. For purposes of discussion, the data access event is sent by a database system (e.g., database system 414) and the received data access event relates to one data element. Note that in cases where multiple data elements are in a data access event, process 600 can be performed for each data element in the data access event.

At 704, a check may be performed to determine whether the data element in the data access event is PII data. For example, a PII data repository that maintains the PII data of the organization (e.g., PII metadata repository 410) can be queried to determine whether the data element is PII data.

If, at 704, a determination is made that the data element is not PII data (i.e., the data element is not a PII data element), then, at 706, the data element may be returned in its normal state to the data base system. The database system can then continue processing the data access event. For example, the database system can return the data element to a requester. In this case, since the data element is not PII data, there is no need for to govern the access to the data element by applying a PII protection policy.

Otherwise, if at 704, a determination is made that the data element is PII data (i.e., the data element is a PII data element), then, at 708, a PII protection policy that is to be applied to the PII data element may be determined. For example, a machine learning model (e.g., PII policy prediction engine 412) can be used to obtain a recommendation of a PII protection policy to apply to the PII data element.

At 710, the PII protection policy determined at 708 may be applied to the PII data element. For example, application of the PII protection policy may modify/alter the PII data element as specified by the applied PII protection policy. In this case, since the data element in the data access event is PII data, access to the PII data element is governed by applying the PII data protection policy.

At 712, the PII data element with the PII protection policy applied may be returned to the database system. The database system can then continue processing the data access event. For example, the database system can return the data element (i.e., the PII data element) to a requester in the modified/altered state as specified by the applied by the applied PII protection policy.

In the foregoing detailed description, various features of embodiments are grouped together for the purpose of streamlining the disclosure. This method of disclosure is not to be interpreted as reflecting an intention that the claims require more features than are expressly recited. Rather, inventive aspects may lie in less than all features of each disclosed embodiment.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

Elements of different embodiments described herein may be combined to form other embodiments not specifically set forth above. Other embodiments not specifically described herein are also within the scope of the following claims.

Reference herein to “one embodiment” or “an embodiment” means that a particular feature, structure, or characteristic described in connection with the embodiment can be included in at least one embodiment of the claimed subject matter. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the words “exemplary” and “illustrative” are used herein to mean serving as an example, instance, or illustration. Any aspect or design described herein as “exemplary” or “illustrative” is not necessarily to be construed as preferred or advantageous over other aspects or designs. Rather, use of the words “exemplary” and “illustrative” is intended to present concepts in a concrete fashion.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical examples to aid the reader in understanding the present disclosure, and are to be construed as being without limitation to such specifically recited examples and conditions. Although illustrative embodiments of the present disclosure have been described in detail, various changes, substitutions, and alterations could be made hereto without departing from the scope of the present disclosure. Accordingly, it is intended that the scope of the present disclosure be limited not by this detailed description, but rather by the claims appended hereto.

What is claimed is:

1. A method comprising:
receiving, by a computing device, a data access event, wherein the data access event relates to a data element;
determining, by the computing device, whether the data element is a personally identifiable information (PII) data element;
responsive to a determination that the data element is a PII data element:
predicting, by the computing device using a machine learning (ML) model, a PII protection policy appropriate for the PII data element; and
applying, by the computing device, the PII protection policy to the PII data element; and
returning, by the computing device, the data access event including the PII data element with the PII protection policy applied.

2. The method of claim 1, wherein the data access event includes an access of a database.

3. The method of claim 1, wherein the ML model includes a CatBoost classifier.

4. The method of claim 1, wherein the ML model is trained with training data comprising historical PII protection data.

5. The method of claim 1, further comprising, responsive to a determination that the data element is not a PII data element, returning, by the computing device, the data access event.

6. The method of claim 1, wherein determining whether the data element is a PII data element includes querying a PII metadata repository, wherein the PII metadata repository maintains PII data of an organization.

7. The method of claim 1, wherein the data access event is from another computing device.

8. A computing device comprising:
one or more non-transitory machine-readable mediums configured to store instructions; and
one or more processors configured to execute the instructions stored on the one or more non-transitory machine-readable mediums, wherein execution of the instructions causes the one or more processors to carry out a process comprising:
receiving a data access event, wherein the data access event relates to a data element;
determining whether the data element is a personally identifiable information (PII) data element;
responsive to a determination that the data element is a PII data element:
predicting, using a machine learning (ML) model, a PII protection policy appropriate for the PII data element; and
applying the PII protection policy to the PII data element; and
returning the data access event including the PII data element with the PII protection policy applied.

9. The computing device of claim 8, wherein the data access event includes an access of a database.

10. The computing device of claim 8, wherein the ML model includes a CatBoost classifier.

11. The computing device of claim 8, wherein the ML model is trained with training data comprising historical PII protection data.

12. The computing device of claim 8, wherein the process further comprises, responsive to a determination that the data element is not a PII data element, returning the data access event.

13. The computing device of claim 8, wherein determining whether the data element is a PII data element includes querying a PII metadata repository, wherein the PII metadata repository maintains PII data of an organization.

14. The computing device of claim 8, wherein the data access event is from another computing device.

15. A non-transitory machine-readable medium encoding instructions that when executed by one or more processors cause a process to be carried out, the process including:
receiving a data access event, wherein the data access event relates to a data element;
determining whether the data element is a personally identifiable information (PII) data element;
responsive to a determination that the data element is a PII data element:
predicting, using a machine learning (ML) model, a PII protection policy appropriate for the PII data element; and
applying the PII protection policy to the PII data element; and
returning the data access event including the PII data element with the PII protection policy applied.

16. The machine-readable medium of claim 15, wherein the data access event includes an access of a database.

17. The machine-readable medium of claim 15, wherein the ML model includes a CatBoost classifier.

18. The machine-readable medium of claim 15, wherein the ML model is trained with training data comprising historical PII protection data.

19. The machine-readable medium of claim 15, wherein the process further comprises, responsive to a determination that the data element is not a PII data element, returning the data access event.

20. The machine-readable medium of claim 15, wherein determining whether the data element is a PII data element includes querying a PII metadata repository, wherein the PII metadata repository maintains PII data of an organization.
